(19) United States
(12) Patent Application Publication
(10) Pub. No.: US 2024/0306681 A1
(43) Pub. Date: Sep. 19, 2024

(54) METHOD FOR FLASH HEAT TREATMENT OF PEA STARCH

(71) Applicant: ROQUETTE FRERES, Lestrem (FR)

(72) Inventors: Julien PARCQ, LILLE (FR); Jovin HASJIM, BETHUNE (FR); Alban DUPONT, CALONNE SUR LA LYS (FR)

(21) Appl. No.: 18/577,026

(22) PCT Filed: Jul. 5, 2022
(86) PCT No.: PCT/FR2022/051348

§ 371 Date: Jan. 5, 2024

(30) Foreign Application Priority Data
Jul. 8, 2021 (FR) FR21 07402

(51) Int. Cl. A23L 11/00; A23L 29/212; C08B 30/06; C08B 30/12; C08L 3/02

(52) U.S. Cl. CPC A23L 11/00; A23L 29/212; C08B 30/06; C08B 30/12; C08L 3/02

(57) ABSTRACT

A method for preparing a legume starch with a high slowly digestible fraction content (SDS), a hydrothermal treatment method wherein it comprises the following steps: 1) preparing a starch milk with a dry matter content of between 30 and 40% by weight; 2) heating the starch milk prepared in this way to a temperature of between 50 and 60° C., preferably 55° C., in a continuous reactor so that the residence time of the starch milk is less than 5 minutes, preferably less than 2 minutes; and 3) recovering, filtering and drying the starch milk treated in this way.

The present invention relates to a hydrothermal method for increasing the content of slowly digestible fraction of pea starch. More particularly, this hydrothermal method is a continuous and rapid method for the heat treatment of pea starch (referred to as a “flash heat treatment”).

It also relates to the pea starch obtained in this way and to the uses thereof.

### FIELD OF THE INVENTION

From a physiological perspective, in humans or animals, the bulk of carbohydrates ingested during eating is represented by starch, an energy storage molecule that is characteristic of plants and a main component of starchy foods (pasta, flour, potatoes).

During digestion, the starch molecules dissociate into smaller, linear glucan chains, which are themselves dissociated into simple glucose molecules that can be absorbed by the digestive system.

Starch digestion starts in the mouth during mastication by virtue of an enzyme in the saliva: salivary amylase.

This initial breakdown of starch is stopped by the acidity of the stomach but resumes in the duodenum (the first part of the small intestine) by virtue of the action of pancreatic and intestinal enzymes.

The successive action of all of these amylases leads to the appearance of a disaccharide, maltose, which itself is converted into two monosaccharides, glucoses.

Synthesized biochemically, a source of carbohydrates, starch is one of the most widespread organic materials in the plant kingdom, where it constitutes organisms' nutrient reserves.

It is thus naturally present in the storage organs and tissues of higher plants, in particular in cereal grains (wheat, corn, etc.), legume grains (peas, beans, etc.), tubers (potatoes, yams, etc.) roots (cassava, sweet potatoes, etc.), bulbs, stems and fruit.

Starch is mainly a mixture of two homopolymers, amylose and amylopectin, composed of D-glucose units bonded to one another via α-(1-4) and α-(1-6) linkages which are the source of branching in the structure of the molecule.

These two homopolymers differ in terms of the degree of branching thereof, and the degree of polymerization thereof.

Amylose is slightly branched with short branches and has a molecular weight between 10,000 and 1,000,000 daltons. The molecule is formed of 100 to 10,000 glucose molecules.

Amylopectin is a branched molecule with branches every 24 to 30 glucose units, via α-(1-6) linkages. The molecular weight thereof ranges from 1,000,000 to 100,000,000 daltons and the degree of branching thereof is about 5%. The total chain can include 10,000 to 100,000 glucose units.

The ratio of amylose to amylopectin depends on the botanical source of the starch.

Starch is stored in storage organs and tissues in a granular state, that is in the form of semi-crystalline granules.

This semi-crystalline state is essentially due to the amylopectin macromolecules.

In the native state, starch granules have a degree of crystallinity that ranges from 15 to 45% by weight which depends substantially on the botanical origin and on the method used for their extraction.

Granular starch placed under polarized light thus has, in microscopy, a characteristic black cross referred to as “Maltese cross”.

This phenomenon of positive birefringence is due to the semi-crystalline organization of the granules: since the average orientation of the polymer chains is radial.

For a more detailed description of granular starch, reference can be made to chapter II, entitled “Structure et morphologie du grain d'amidon” [“Structure and morphology of the starch grain”] by S. Perez, in the work “Initiation à la chimie et à la physico-chimie macromoléculaires” [“Introduction to macromolecule chemistry and physical chemistry”], first edition, 2000, volume 13, pages 41 to 86, Groupe Français d'Etudes et d'Applications des Polymères [French Polymer Group].

Dry starch contains a water content which ranges from 12 to 20% by weight depending on the botanical origin. This water content obviously depends on the residual moisture of the medium (for an a_{w}=1, the starch can fix up to 0.5 g of water per gram of starch).

Heating, with excess water, a starch suspension to temperatures close to its gelatinization temperature leads to irreversible swelling of the granules and leads to the dispersion thereof, and then the dissolution thereof.

It is these properties in particular which give starch its technological properties of interest.

For a given temperature range, referred to as “gelatinization range”, the starch grain will very quickly swell and lose its semi-crystalline structure (loss of birefringence).

Generally, all of the granules will be as swollen as possible over a temperature range of about 5 to 20° C. A paste is obtained composed of swollen granules which constitute the dispersed phase, and molecules (mainly amylose) which thicken the aqueous continuous phase.

The rheological properties of the paste depend on the relative proportion of these two phases and on the swelling volume of the granules. The gelatinization range is variable depending on the botanical origin of the starch.

The maximum viscosity is obtained when the starch paste contains a large number of highly swollen granules. When heating is continued with shear, the granules will burst and the material will disperse in the medium.

Amylose-lipid complexes have delayed swelling because the combination prevents the interaction of the amylose with the water molecules, and temperatures of greater than 90° C. are necessary in order to obtain the total swelling of the granules (amylomaize being complexed to the lipids).

The disappearance of the granules and the dissolution of the macromolecules leads to a reduction in the viscosity.

Lowering the temperature (by cooling) of the starch pea causes gelling or insolubilization of the macromolecules, and then crystallization of these macromolecules is observed.

This phenomenon is known by the name retrogradation.

When a paste contains amylose, it is this first molecule which will undergo retrogradation.

It will consist in the formation of a double helix and the combination of the latter to form “crystals” which will give rise to a three-dimensional network via junction zones.

This network is formed very quickly, in a few hours, and continues to develop for up to a few weeks. The association of the molecules with one another via hydrogen bridge bonds forming double helices displaces the associated water molecules in the network and gives rise to significant syneresis.

The structural complexity of the starch and its physico-chemical properties mean that this class of carbohydrate will be assimilated then digested in a variable way in humans and animals.

This is why starch can be classified into three categories, depending on its digestibility: rapidly digestible, slowly digestible, or non-digestible.

Starch, which occurs in naturally granular/semi-crystalline form, can be converted into “rapidly digestible starch” (RDS) after exposure to heat, pressure and/or moisture during food processes.

Slowly digestible starch (SDS) takes longer to be broken down by digestive enzymes compared to RDS because it still has a crystalline structure and is less accessible to digestion enzymes.

Digestion of this SDS fraction leads to a moderate and regular release of glucose into the blood. These are known as low G.I. starches (for “low glycemic index”).

Foods with high SDS content will then elicit lower postprandial glycemic responses and lower postprandial insulin responses than foods with only low SDS content.

Conversely, RDSs are nutritious carbohydrates because they release their glucose into the blood much faster. However, care should be taken that the nutrient source does not contain too much thereof, which can lead to metabolic syndrome.

As for the so-called resistant starches (RS), these are, in turn, comparable to fibers (such as corn bran, oat fibers, gums) which cannot be digested by intestinal enzymes.

It is accepted in the prior art that total starch is the sum of its three components: RDS, SDS and RS.

The different types of starch are therefore digested at different rates in the human digestive system.

It is therefore assumed that SDS has a slower digestion rate than RDS. RS is a fraction of starch that is resistant to enzymatic digestion in the small intestine. This fraction is fermented in the large intestine and can therefore be considered as dietary fiber.

The SDS and RDS fractions are therefore sources of available glucose.

SDSs are naturally present in some uncooked seeds of cereals such as wheat, rice, barley, rye, corn, and in legumes such as peas, field beans and lentils.

The SDS content is mainly influenced by the gelatinization of starch during the food process which will follow.

Indeed, during this process, exposure to temperature, pressure and moisture leads to the conversion of the SDS fraction into RDS, making the starch more accessible to enzymatic digestion.

This conversion can be minimized by controlling the cooking conditions to limit the gelatinization of the starch.

Therefore, the original content of SDS in the composition or the food product will depend on the way in which its preparation has been carried out.

It is therefore known that food products which contain a lot of SDS are certain pastas, parboiled rice, pearl barley and certain cookies, unlike puffed breakfast cereals or bread which usually contain very little.

The SDS content of foods is conventionally determined using an in vitro method developed by H. N. ENGLYST and his collaborators (published in 1992 in the European Journal of Clinical Nutrition, volume 46, pages S33-S50).

In the remainder of this presentation, reference will be made to this 1992 method “according to ENGLYST”.

This method was developed to simulate the enzymatic digestion that occurs in the small intestine.

A sample of product or starch is introduced into a tube, in the presence of digestive enzymes, and the release of glucose is measured during 120 minutes of reaction.

This method makes it possible to differentiate:
The RDS fraction, by measuring rapidly available glucose (RAG); in this case, measuring the glucose released between 0 and 20 minutes;
The SDS fraction, by measuring slowly available glucose (SAG); in this case, measuring the glucose released between 20 and 120 minutes;
The RS fraction, corresponding to glucose not released after 120 minutes, which is calculated according to the ENGLYST method by the following formula: TS−(RDS+SDS) where TS=total starch (total starch considered equal to 100% when analyses are carried out on starch as such).

Foods rich in carbohydrates containing more than 50% by weight of available carbohydrates from starch, of which at least 40% by weight are SDS, are conventionally considered to be foods high in SDS.

They are therefore recommended for limiting the glycemic index and insulin production, compared to foods with a lower SDS content.

Of all the starches conventionally used in these food applications, legume starches, and more particularly pea starch, are a prime candidate.

Indeed, pea seeds are known for their high starch content (between 55 and 70% by weight of dry matter) and for their low glycemic index (RATNAYAKE et al. “Pea starch, composition, structure and properties—A review”, Starch/Stärke, 2002, vol. 54, pp. 217-234).

Native pea starches, exhibiting an SDS content conventionally between 27 and 38% by weight according to ENGLYST, are therefore of interest for nutritional applications.

However, in order to prepare foods with high SDS content, it is necessary to use starch with a higher fraction of slowly digestible carbohydrate.

It is known in the prior art that annealing-type heat treatments make it possible to alter the crystal structure of the starch granule.

However, it is known in the prior art that the main objective of annealing processes is not to increase the slowly digestible fraction (SDS) content, but rather to make starch, and in particular legume starch such as pea starch, more digestible (see the article by CHUNG et al., in Carbohydor. Polym., 2009, vol. 75, pp. 436-447), by increasing the RDS fraction content.

Now, in its patent application WO 2021/099747, the applicant company has optimized this annealing technology, not to increase the RDS fraction, but rather to increase the SDS content of legume starch, especially pea starch, by seeking and finding annealing process conditions that are particularly suited to this purpose.

Still, there remains a limitation on the annealing method itself. Specifically, this treatment is normally carried out in the context of a discontinuous process, which requires heating at a target temperature for at least 30 minutes.

The aim of the heating time in the discontinuous process is to balance the temperature between the heat source and the middle of the container (or reactor) and to allow the starch crystallites to be rearranged (annealing effect).

A larger reactor will require a longer heating time due to the longer path between the heat source and the middle of the container. Similarly, a higher solid content will require a longer heating time due to the higher viscosity.

The applicant company has therefore decided to optimize this annealing method by finding operating conditions that allow the SDS content of the legume starch, in particular pea starch, to be increased by implementing a continuous method with a much shorter heating time than that of the basic annealing method.

### BRIEF DESCRIPTION OF THE DRAWINGS

Other features, details and advantages will appear from reading the following detailed description, and by analyzing the appended drawings in which:

FIG. 1 shows a thermal cooker according to one embodiment of the invention comprising three baths in series.

### DETAILED DESCRIPTION

Thus, the invention relates to a method for preparing a legume starch, preferably pea starch, with a high slowly digestible fraction (SDS) content, which method is a hydrothermal treatment method characterized in that it comprises the following steps:
1) preparing a starch milk with a dry matter content of between 30 and 40%, preferably between 35 and 37% by weight;
2) heating the starch milk prepared in this way to a temperature of between 48 and 60° C., preferably 55° C., in a continuous reactor so that the residence time of the starch milk is less than 5 minutes, preferably less than 2 minutes; and
3) recovering, filtering and drying the starch milk treated in this way.

In the meaning of the present invention, “high slowly digestible fraction content” is understood to mean an SDS content increase of 5 to 25% by dry weight, preferably 10 to 20% by dry weight with respect to the starch from which it is prepared.

For the purposes of the present invention, “legume” means any plant belonging to the families of the cesalpiniaceae, mimosaceae or papilionaceae, and particularly any plant belonging to the family of the papilionaceae, for example pea, bean, broad bean, field bean, lentil, alfalfa, clover or lupin.

This definition includes in particular all of the plants described in the tables in the article by HOOVER et al. entitled “Composition, structure, functionality and chemical modification of legume starches: a review”, Can. J. Physiol. Pharmacol, 1991, vol. 69 pp. 79-92).

Preferably, the legume is selected from the group comprising pea, bean, broad bean and field bean.

Advantageously, it is pea, the term “pea” being considered here in its broadest sense and including in particular:
all the wild-type varieties of “smooth pea”, and
all the mutant varieties of “smooth pea” and of “wrinkled pea”, regardless of the uses for which said varieties are usually intended (human food, animal feed and/or other uses).

Said mutant varieties are in particular those called “r mutants”, “rb mutants”, “rug 3 mutants”, “rug 4 mutants”, “rug 5 mutants” and “lam mutants” as described in the article by HEYDLEY et al., entitled “Developing novel pea starches”, Proceedings of the Symposium of the Industrial Biochemistry and Biotechnology Group of the Biochemical Society, 1996, pp. 77-87.

According to another advantageous variant, legumes (for example varieties of pea or field bean) are plants giving grains containing at least 25%, preferably at least 40%, by weight of starch (dry/dry).

“Legume starch” is intended to mean any composition extracted, by any means, from a legume and in particular from a papilionaceae, the starch content of which is greater than 40%, preferably greater than 50% and even more preferentially greater than 75%, these percentages being expressed as dry weight relative to the dry weight of said composition.

Advantageously, this starch content is greater than 90% (dry/dry). It can in particular be greater than 95% by weight, including greater than 98% by weight.

“Native” starch means a starch which has not undergone any chemical modification.

In order to determine their base content of SDS fraction, pea starches, according to the invention or not, are analyzed according to the in vitro digestion process conditions of the method by ENGLYST et al. entitled “Classification and measurement of nutritionally important starch fractions”, Eur. J. Clin. Nutr., 1992, vol. 46 (Supp. 2), pp. S33-S50.

The method consists of measuring the fractions of rapidly digestible starch (RDS), slowly digestible starch (SDS) and non-digestible (resistant) starch (RS) contained in a food.

These fractions are determined after enzymatic digestion with pancreatin, amyloglucosidase and invertase.

The released glucose is measured by colorimetry, using a Glucose GOD FS glucose oxidase kit, referenced 1 2500 99 10 923, marketed by the company DiaSys Distribution France Sarl, following the protocol of said kit.

The detail of the method implemented for measuring digestion according to ENGLYST is similar to that given by the applicant company in its patent application WO 2021/099747.

Reagents used:
Anhydrous sodium acetate (ref: 71184, from SIGMA)
Benzoic acid (ref: 242381, from SIGMA)
CaCl₂ (ref: 1.02378.0500, from MERCK)
Acetic acid, 0.1 M (ref: 33209, from SIGMA)
Pig pancreatin 8× USP (ref: P 7545 from SIGMA)
Amyloglucosidase EC 3.2.1.3 (from SIGMA, with activity ≥260 U/mL/≈300 AGU/mL, Cat. NO. A7095)
Invertase EC 3.2.1.26 (from SIMA, with activity ≥300 units/mg solid, Cat. NO. I-4504)
Guar (ref: G4129, from SIGMA)
Ethanol at 66°

### Procedure

The acetate buffer (0.1 M) was prepared by dissolving 8.203 g of anhydrous sodium acetate in 250 ml of saturated benzoic acid solution, diluting it to 500 ml with RO water, adjusting the pH to 5.2 with 0.1 M acetic acid, diluting it again to 1000 ml with RO water and adding 4 ml of 1 M CaCl₂ per liter of buffer.

The enzyme solution was freshly prepared before the experiments. Four 50 ml centrifuge tubes were prepared, each containing 2.5 g of pig pancreatin (8× USP, P7545, Sigma) mixed with 20 ml of RO water. The mixture was stirred for 10 minutes and centrifuged for 10 minutes at 1500× g.

The supernatants (13.5 ml for each tube) were combined and mixed with 2.775 ml of amyloglucosidase (EC 3.2.1.3, A7095, Sigma), 3.225 ml of RO water and 33.3 mg of invertase (EC 3.2.1.26, 14504, Sigma) predissolved in 4 ml of RO water.

Each sample (0.8 g, dry basis) was mixed with 20 ml of acetate buffer and 50 mg of guar gum in a 50 ml tube.

A “blank” control was prepared using 20 ml of acetate buffer and 50 mg of guar gum, without any sample, while a standard contained 0.5 g of anhydrous glucose and 50 mg of guar gum in 20 ml of acetate buffer solution.

The guar gum can be predissolved in the acetate buffer; for example, 750 mg of guar gum in 300 ml of acetate buffer.

The samples, the blank and the standard were equilibrated at 37° C. in a water bath with stirring for 15 minutes.

An aliquot (0.1 ml) was taken from each tube before adding the enzymes (0 minute) and mixed with 0.9 ml of 66% ethanol solution. Taking one tube per minute, 5 ml of enzyme solution were added to the samples, to the blank and to the standard.

Immediately after mixing, the tubes were placed in the water bath at 37° C. for 120 min with stirring.

An aliquot (0.1 ml) was taken from each tube at 20 and 120 minutes and mixed with 0.9 ml of 66% v/v ethanol solution.

The mixtures of solutions with alcohol were centrifuged at 1500× g for three minutes.

The glucose content (G₀, G₂₀ and G₁₂₀ for 0, 20 and 120 minutes, respectively) in each supernatant was analyzed using a colorimetric method, and used to calculate the rapidly digestible starch (RDS), slowly digestible starch (SDS) and resistant starch (RS) as follows:

$$\begin{matrix}RDS = ( {G}_{20} - {G}_{0} ) \times 0.9 \\ SDS = ( {G}_{120} - {G}_{20} ) \times 0.9 \\ RS = 100 \% - ( RDS + SDS ) = 100 \% - ( {G}_{120} \times 0.9 )\end{matrix}$$

The conventional ENGLYST method does not allow the starch samples to be hydrolyzed to exhaustion since, as the applicant company has observed, a greater amount of starch can be hydrolyzed after two hours of reaction.

This observation allowed the applicant company to make use of this property by revealing the presence of a very slowly digestible fraction, originating from the RS fraction of pea starch, in its patent application WO 2021/099748. This fraction was defined as the vSDS fraction (for very slowly digestible starch).

Therefore, the AOAC 2002.02 method, which uses 16-hour hydrolysis, was used to obtain the absolute RS content, and the result can be claimed as a dietary fiber.

To differentiate between the two levels of RS, the parameters RS_{E} and RS_{A} were used to denote the RS contents obtained by the ENGLYST method (RS_{E}) and by AOAC 2002.02 (RS_{A}), respectively.

The difference between RS_{E} and RS_{A} is considered to be the very slowly digestible starch (vSDS), the digestible part of starch which requires more than two hours to be hydrolyzed using the ENGLYST method.

According to this method, native pea starch conventionally has the following content:
an RDS content of between 13 and 16% by weight,
an SDS content of between 24 and 38% by weight,
an RS_{E} content of between 50 and 65% by weight,
an RS_{A} content of between 9 and 20% by weight,
a vSDS content of between 35 and 45% by weight.

To increase the level of SDS, the flash heat treatment method according to the invention, developed by the applicant company, uses a precise hydrothermal approach.

The invention thus relates to a method for preparing a legume starch, preferably pea starch, with a high slowly digestible fraction (SDS) content, which method is a hydrothermal treatment method characterized in that it comprises the following steps:
1) preparing a starch milk with a dry matter content of between 30 and 40%, preferably between 35 and 37% by weight;
2) heating the starch milk prepared in this way to a temperature of between 50 and 60° C., preferably 55° C., in a continuous reactor so that the residence time of the starch milk is less than 5 minutes, preferably less than 2 minutes; and
3) recovering, filtering and drying the starch milk treated in this way.

The first step of said method according to the invention consists of preparing a legume starch milk, in this particular case a pea starch milk, with a dry matter content of between 30 and 40% by weight, preferably 32% by weight.

The second step of the method according to the invention consists of heating the starch milk prepared in this way to a temperature of between 48 and 60° C., preferably 55° C., in a continuous reactor so that the residence time of the starch milk is less than 5 minutes, preferably less than 2 minutes.

This temperature of the starch milk is that measured at the outlet of the heat treatment device.

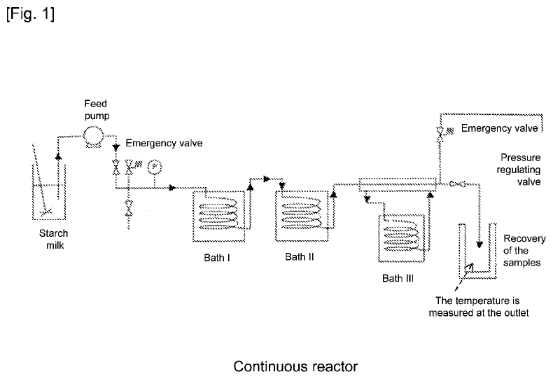

The applicant company recommends using a thermal cooker of which the bath temperature does not exceed 65° C. As will be exemplified below, in the laboratory device used in one exemplary implementation of the method according to the invention, the thermal cooker used in the examples comprises three baths in series (see FIG. 1). However, this device can be replaced with any other device which allows a continuous method to be implemented. A person skilled in the art will know how to select the dimensions, the number of baths, and the throughput suitable for each device in order to carry out this second step under suitable conditions.

Other devices that allow the method according to the invention to be carried out are, for example, those used to pasteurize dairy products, such as plate exchangers or tube exchangers.

Advantageously, the second step can be preceded by a preheating step, for example at a temperature of between 35 and 45°, preferably about 40° C., for enough time to allow the starch milk to reach a temperature closer to that of step 2). The duration of this optional preheating step will be readily determined by a person skilled in the art according to the exact configuration of the device.

The third and final step of the method according to the invention thus consists of recovering, filtering and drying the starch milk treated in this way, as exemplified hereinafter.

The residual moisture content of the obtained dry starch is less than 15% by weight, preferably less than or equal to 12% by weight.

The ENGLYST digestibility measurement of these products gives SDS values that are 8 to 25% higher by dry weight, preferably 12 to 20% higher by dry weight with respect to the initial starch from which it was prepared.

As will be shown below, this SDS value for pea starch is over 35% by weight, preferably between 40 and 55% by weight.

The present invention also relates to a pea starch with a high slowly digestible fraction content prepared according to one of the methods described above, characterized in that the SDS content is greater than 35% by weight, preferably between 40 and 50% by weight.

These starches with high SDS content will then be advantageously used in fields of application relating to food (intended especially for sportspersons) or medicine (specialist nutrition).

The invention also relates to the use of a starch according to the invention in the food and medical fields of application, especially for food for sportspersons or specialist nutrition.

The invention will be better understood on reading the following examples, which are intended to be illustrative, only mentioning certain embodiments and certain advantageous properties according to the invention, and are non-limiting.

### EXAMPLE 1: FLASH HEAT TREATMENT OF PEA STARCH, HAVING AN SDS CONTENT OF 33%, AT DIFFERENT TEMPERATURES

A pea starch suspension (pea starch LN30 marketed by the applicant company—batch 1) of 32% dry matter in demineralized water was heated in the laboratory cooker of FIG. 1 to reach a temperature of 50, 52, 55 or 59° C. at the outlet.

The system was run with water until the cooker temperature was stable, and then the water was replaced with the pea starch suspension.

The temperatures of the three baths were adjusted until the desired temperature was obtained at the outlet of the laboratory cooker (see Table I).

A thermal cooker comprising 3 baths in series was used in this example. However, if the dimensions allow, it can be replaced with a cooker allowing a continuous process that comprises a single bath at the desired temperature.

The pea starch suspension was preheated to 40° C. to reduce the time required to reach the target temperature in the laboratory cooker. The throughput of the starch suspension was about 200 mL/min. The residence time was less than 2 minutes.

The treated starch was filtered through a Büchner funnel with a sintered disc with no.3 porosity, then dried using a fluidized bed dryer (TG 200, Retsch) at 60° C. until a moisture content equal to or less than 12% was reached, and ground using a food processor (Thermomix TM3300, Vorwerk, Germany).

TABLE I

| | Temperature (° C.) | | | Temperature at |
|---|---|---|---|---|
| | Bath I | Bath II | Bath III | outlet (° C.) |
| 1 | 57.5 | 55 | 50 | 49-50 |
| 2 | 55 | 55 | 55 | 51-52 |
| 3 | 60 | 60 | 60 | 54-55 |
| 4 | 65 | 65 | 65 | 58-59 |

In vitro digestibility of the treated pea starch was analyzed according to ENGLYST as indicated above, and the results presented in Table II below.

TABLE II

| | RDS | SDS | RS_{E} | RS_{A} | vSDS |
|---|---|---|---|---|---|
| | (%) | (%) | (%) | (%) | (%) |
| Pea starch LN 30 | 16 | 33 | 51 | 9.7 | 41.3 |
| batch 1 | | | | | |
| 1 | 21 | 36 | 43 | 3.3 | 39.7 |
| 2 | 21 | 38 | 41 | 3.9 | 37.1 |
| 3 | 25 | 37 | 38 | 3 | 35 |
| 4 | 31 | 52 | 17 | 2.7 | 14.3 |

Treatments 1, 2 and 3 produced a starch having similar digestibility properties, slightly increasing the RDS and SDS contents of the basic native pea starch, while decreasing the RS_{E} and RS_{A} (Table II).

Treatment 4 had the highest SDS and RDS contents, with the SDS content also being higher than the RDS content.

Treatment 4 also contained the lowest RS_{E} and RS_{A}. The RS_{A} contents were very similar among the treated samples, being very low (<4%), which indicates that most of the RSE was in fact vSDS.

The gelatinization properties were analyzed using the DSC 8000 (Perkin Elmer, USA). Each starch sample was mixed with water to obtain an 18% (w/w) starch suspension. The starch suspension (15 mg) was placed in an aluminum crucible and hermetically sealed. It was then equilibrated at 5° C. before being heated from 5° C. to 110° C. at 10° C./min.

The onset temperature (Tₒ), the peak temperature (Tₚ), the conclusion temperature (T_{c}) and the gelatinization enthalpy were determined from their thermograms.

The results are presented in Table III below.

TABLE III

| | Tₒ (° C.) | Tₚ (° C.) | T_{c} (° C.) | ΔH (J/g starch) |
|---|---|---|---|---|
| Pea starch LN 30 | 63.4 | 71.2 | 78.2 | 13.6 |
| batch 1 | | | | |
| 1 | 63.1 | 70.9 | 78.4 | 14.3 |
| 2 | 62.9 | 71.0 | 77.8 | 14.2 |
| 3 | 63.4 | 71.0 | 78.6 | 13.8 |
| 4 | 66.2 | 71.8 | 78.2 | 13.3 |

Treatments 1, 2 and 3 show slight changes in the gelatinization properties of the native pea starch, whereas treatment 4 increased Tₒ, while the other properties were similar to those of the native pea starch (Table III).

The increase in Tₒ is an indicator of the annealing effect, which explains the substantial change in the digestibility of the pea starch after treatment 4.

### EXAMPLE 2: FLASH HEAT TREATMENT OF TWO BATCHES OF PEA STARCH HAVING 24 AND 34% SDS, RESPECTIVELY

Two pea starch suspensions (native pea starch N-735 and pea starch LN30—batch 2 from the applicant company) with 32% or 37% dry matter in demineralized water were treated in a laboratory cooker at 55° C.

The system was run with water until the cooker temperature was stable, and then the water was replaced with the pea starch suspension.

The concentration of the starch suspension and the temperatures of the three baths of the laboratory cooker are given in Table IV.

The pea starch suspension was preheated to 40° C. to reduce the time required to reach the target temperature in the laboratory cooker.

The throughput of the starch suspension was about 200 mL/min.

The residence time was less than 2 minutes.

The treated starch was filtered through a Büchner funnel with a sintered disc with no.3 porosity, then dried using a fluidized bed dryer (TG200, Retsch) at 60° C. until a moisture content equal to or less than 12% was reached, and ground using a food processor (Thermomix TM3300, Vorwerk, Germany).

TABLE IV

| | Type of | Concentration of | | | | |
|---|---|---|---|---|---|---|
| | pea | the starch | Temperature (° C.) | | | Temperature |
| Treatment | starch | suspension (%) | Bath I | Bath II | Bath IIII | at outlet (° C.) |
| 5A | LN 30 | 32 | 55 | 55 | 55 | 49 |
| | batch 2 | | | | | |
| 5B | LN 30 | 37 | 55 | 55 | 55 | 49 |
| | batch 2 | | | | | |
| 6 A | N-735 | 32 | 55 | 55 | 55 | 49 |
| 6B | N-735 | 37 | 55 | 55 | 55 | 49 |
| 6C | N-735 | 37 | 55 | 55 | 55 | 50 |

In vitro digestibility of the treated pea starch was analyzed according to ENGLYST as indicated above, and the results presented in Table V below.

TABLE V

| | RDS | SDS | RS_{E} | RS_{A} | vSDS |
|---|---|---|---|---|---|
| | (%) | (%) | (%) | (%) | (%) |
| LN 30 batch 2 | 13 | 34 | 53 | 16 | 37 |
| 5A | 27 | 42 | 30 | 6 | 24 |
| 5B | 25 | 42 | 34 | 5 | 28 |
| N-735 | 15 | 24 | 61 | 17 | 44 |
| 6 A | 19 | 36 | 45 | 8 | 37 |
| 6B | 27 | 36 | 36 | 9 | 28 |
| 6C | 20 | 35 | 45 | 9 | 36 |

The RSE contents were highest in the native pea starches, followed by their vSDS contents. Most of the RS_{E} contents were vSDS because the RS_{A} contents were less than 50% of the RS_{E} contents.

The 32% and 37% starch suspensions showed similar in vitro digestibility results (Table V).

All of the treated samples showed higher RDS and SDS contents and lower RS_{E} and RS_{A} contents than their native homologues.

The RDS contents of the treated starches were always less than 30% and were lower than their SDS contents.

The decreases in the RS_{E} contents were greater than the decreases in the RS_{A} contents, reducing their differences, indicating that the vSDS contents decreased after treatment. However, in general, more than 70% of the RS_{E} contents were still vSDS.

TABLE VI

| | Tₒ (° C.) | Tₚ (° C.) | T_{c} (° C.) | ΔH (J/g starch) |
|---|---|---|---|---|
| LN 30 batch 2 | 62.1 | 70.2 | 77.8 | 13.4 |
| 5A | 61.8 | 69.8 | 77.4 | 13.3 |
| 5B | 64.0 | 70.0 | 77.9 | 14.3 |
| N-735 | 61.0 | 69.3 | 78.2 | 13.6 |
| 6 A | 61.0 | 69.0 | 78.0 | 13.7 |
| 6B | 61.3 | 68.9 | 78.2 | 13.2 |
| 6C | 60.3 | 68.7 | 78.6 | 14.4 |

The changes in the gelatinization properties after the treatment were less apparent (Table VI).

1. A method for preparing a legume starch with a high slowly digestible fraction (SDS) content, which method is a hydrothermal treatment method wherein it comprises the following steps:
1) preparing a starch milk with a dry matter content of between 30 and 40% by weight;
2) heating the starch milk prepared in this way to a temperature of between 50 and 60° C., preferably 55° C., in a continuous reactor so that the residence time of the starch milk is less than 5 minutes, preferably less than 2 minutes; and,
3) recovering, filtering and drying the starch milk treated in this way.

2. The method according to claim 1, wherein the legume starch is selected from the group of pea, bean, broad bean, field bean, lentil, alfalfa, clover and lupine starches, and is particularly pea starch.

3. The method according to claims 1, wherein the high slowly digestible fraction (SDS) content corresponds to an increase of 5 to 25% by dry weight, preferably 10 to 20% by dry weight, with respect to the initial starch.

4. The pea starch with a high slowly digestible fraction content prepared according to the method of claim 1, wherein the SDS content is greater than 35% by weight, preferably between 40 and 55% by weight.

5. The use of a starch according to claim 4 in food fields of application, especially for food for sportspersons.
